(19) United States
(12) Patent Application Publication
(10) Pub. No.: US 2020/0075962 A1
(43) Pub. Date: Mar. 5, 2020

(54) MANUFACTURING METHOD AND MANUFACTURING APPARATUS FOR GAS DIFFUSION LAYER

(71) Applicant: TOYOTA JIDOSHA KABUSHIKI KAISHA, Toyota-shi (JP)

(72) Inventors: Yukihiro SHIBATA, Toyota-shi (JP); Takeyuki KURIYAMA, Nagoya-shi (JP)

(73) Assignee: TOYOTA JIDOSHA KABUSHIKI KAISHA, Toyota-shi (JP)

(21) Appl. No.: 16/553,577

(22) Filed: Aug. 28, 2019

(30) Foreign Application Priority Data
Sep. 4, 2018 (JP) 2018-165122
Feb. 27, 2019 (JP) 2019-034125

(51) Int. Cl. H01M 4/88

(52) U.S. Cl. CPC H01M 4/8817; H01M 4/8807

(57) ABSTRACT

A manufacturing method for a gas diffusion layer includes: a coating step of coating a carbon paste on a front surface of a porous base material in a sheet shape; and a blowing step of injecting a gas onto a back surface of the porous base material opposite to the front surface on which the carbon paste is coated.

### INCORPORATION BY REFERENCE

The disclosure of Japanese Patent Application No. 2019-034125 filed on Feb. 27, 2019 including the specification, drawings and abstract is incorporated herein by reference in its entirety.

### BACKGROUND

### 1. Technical Field

The present disclosure relates to a manufacturing method and a manufacturing apparatus for a gas diffusion layer which is manufactured by coating a carbon paste on a porous base material.

### 2. Description of Related Art

As a manufacturing method of this type, disclosed is a manufacturing method for a gas diffusion layer, including: a conveying step of conveying a porous base material included in the gas diffusion layer; and a coating step of coating an electric conductive carbon paste on one surface of the porous base material being conveyed (see Japanese Patent Application Publication No. 2015-50073 (JP 2015-50073 A)). This manufacturing method is performed, for example, by a manufacturing apparatus 1 shown in FIG. 12. The manufacturing apparatus 1 includes: a conveying mechanism 4 including a back roll 2 and a conveying roll 3; and a coating mechanism 6 including a coating head 5. The manufacturing apparatus 1 is configured to coat a carbon paste 8 by a coating head 5 on a front surface 7a of a porous base material 7 being conveyed by the back roll 2 and the conveying roll 3 so as to produce the gas diffusion layer.

### SUMMARY

Unfortunately, as shown in an enlarged sectional view of FIG. 12, the manufacturing method for a gas diffusion layer described in JP 2015-50073 A has such a problem that the carbon paste 8 coated on the surface 7a of the porous base material 7 passes through the inside of the porous base material 7 by capillary action and penetrates to the back surface 7b of the porous base material 7. As a result, this method causes a problem that pores of the porous base material 7 might be clogged with the carbon paste 8, which might result in impairment of the gas diffusion function of the porous base material 7.

The present disclosure provides a manufacturing method and a manufacturing apparatus for a gas diffusion layer capable of preventing a carbon paste coated on a front surface of a porous base material from penetrating to the back surface of the porous base material, and also preventing the pores of the porous base material from being clogged by the carbon paste.

A manufacturing method for a gas diffusion layer according to one aspect of the present disclosure, includes: a coating step of coating a carbon paste on a front surface of a porous base material in a sheet shape; and a blowing step of injecting a gas onto a back surface of the porous base material opposite to the front surface on which the carbon paste is coated in the coating step.

The carbon paste coated on the front surface of the porous base material penetrates from the front surface into the inside of the porous base material by capillary action. With the above configuration, since the back surface of the porous base material is blown with the gas, the carbon paste receives a force in the direction opposite to the direction of the penetration, so that it becomes difficult for the carbon paste to move in the direction of its penetration, and at the same time, drying of the carbon paste is promoted from the side of the back surface of the porous base material; therefore, the penetration of the carbon paste into the porous base material is suppressed. Accordingly, the penetration of the carbon paste can be stopped at an appropriate position inside the porous base material; and the carbon paste is suppressed from passing through the inside of the porous base material and penetrating to the back surface of the porous base material, thus preventing the pores of the porous base material from being clogged by the carbon paste.

The manufacturing method for a gas diffusion layer according to one aspect of the present disclosure may further include a conveying step of conveying the porous base material by bringing a roll into contact with the back surface of the porous base material, wherein the coating step and the blowing step may be performed on the porous base material being conveyed in the conveying step.

With this configuration, the coating on the front surface and the blowing of the back surface with the gas are performed while the porous base material is being conveyed, and thus the gas diffusion layer can be manufactured more easily and in a shorter time.

In the manufacturing method for a gas diffusion layer according to one aspect of the present disclosure, in the conveying step, the porous base material may be conveyed such that in at least a part of the porous base material, the front surface of the porous base material is located on a lower side in a direction of gravity and the back surface of the porous base material is located on an upper side in the direction of gravity, and in the coating step, the coating may be performed on the front surface located on the lower side in the direction of gravity.

With this configuration, gravity acts on the carbon paste coated on the front surface of the porous base material, and the carbon paste receives a force in the direction opposite to the direction of penetration into the porous base material, and thus the carbon paste becomes difficult to move in the penetrating direction, thereby suppressing the penetration of the carbon paste into the porous base material. Hence, the penetration of the carbon paste can be stopped at an appropriate position inside the porous base material, the carbon paste is suppressed from passing through the inside of the porous base material to penetrate to the back surface of the porous base material, and thus the pores of the porous base material can be prevented from being clogged by the carbon paste.

In the manufacturing method for a gas diffusion layer according to one aspect of the present disclosure, in the conveying step, a conveying direction of the porous base material horizontally supplied such that the front surface is located on the lower side in the direction of gravity and the back surface is located on the upper side in the direction of gravity may be changed upward in a direction opposite to the direction of gravity, in the coating step, the coating may be performed on the front surface of the porous base material being horizontally conveyed, and in the blowing step, the gas may be injected onto the back surface of the porous base material being conveyed along the direction opposite to the direction of gravity.

With this configuration, the conveying step, the coating step, and the blowing step can be arranged in the direction of gravity to overlap one another. Therefore, the size of the entire apparatus can be reduced as compared to the case in which the respective steps are horizontally arranged side by side. This means that an overall plane of the apparatus, which is occupied to perform all these steps, is reduced.

In the manufacturing method for a gas diffusion layer according to one aspect of the present disclosure, the roll may be provided with a blowout port, and in the blowing step, the gas may be injected from the blowout port of the roll so as to blow the back surface of the porous base material in contact with the roll with the gas.

With this configuration, since the gas is injected from the blowout port formed in the roll, and the back surface of the porous base material is blown with the gas, against the coating pressure that acts on the carbon paste in the coating step, air pressure acts on the porous base material from the back surface of the porous base material in the thickness direction; therefore, it is possible to prevent the carbon paste coated from excessively penetrating into the porous base material.

In the manufacturing method for a gas diffusion layer according to one aspect of the present disclosure, in the coating step, the coating may be performed on the front surface of the porous base material at a position where the porous base material is in contact with the roll.

With this configuration, the conveying step and the blowing step can be both performed at the same place by the roll. Therefore, compared with the case in which the conveying step and the blowing step are performed in different places, a distance between the steps can be shortened and the manufacturing for the gas diffusion layer can be performed more simply and in a shorter time.

A manufacturing apparatus for a gas diffusion layer according to another aspect of the present disclosure, includes: a conveying section configured to convey a porous base material in a sheet shape; a coating section configured to coat a carbon paste on a front surface of the porous base material being conveyed by the conveying section; and a blowing section configured to inject a gas onto a back surface of the porous base material that is an opposite surface to the front surface on which the carbon paste is coated by the coating section.

The carbon paste coated on the front surface of the porous base material by coating head penetrates from the front surface into the inside of the porous base material by capillary action. With the above configuration, since the back surface of the porous base material is blown with the gas, the carbon paste receives a force in the direction opposite to the penetrating direction, so that it becomes difficult for the carbon paste to move in the direction of its penetration, and at the same time, the drying of the carbon paste is promoted from the side of the back surface of the porous base material; thus, the penetration of the carbon paste into the porous base material is suppressed. Therefore, the penetration of the carbon paste can be stopped at an appropriate position inside the porous base material, and the carbon paste is suppressed from penetrating through the porous base material and penetrating to the back surface of the porous base material, thus preventing the pores of the porous base material from being clogged by the carbon paste.

In the manufacturing apparatus for a gas diffusion layer according to another aspect of the present disclosure, the conveying section may include: a back roll configured to come into contact with the back surface of the porous base material; and a conveying roll configured to come into contact with the back surface of the porous base material downstream of the back roll in a conveying direction of the porous base material, and the coating section may include a coating head disposed at a position facing the back roll with the porous base material interposed between the coating head and the back roll, and the blowing section may include a blower disposed at a position between the back roll and the conveying roll, the blower arranged to face the back surface of the porous base material.

With this configuration, when the carbon paste is coated on the front surface of the porous base material by the coating head, and penetrates from the front surface into the inside of the porous base material by capillary action, the back surface of the porous base material is blown with the gas; thus, the carbon paste receives a force in the direction opposite to the penetrating direction, so that it becomes difficult for the carbon paste to move in the direction of its penetration, and at the same time, the drying of the carbon paste is promoted from the side of the back surface of the porous base material; therefore, the penetration of the carbon paste into the porous base material is suppressed. Accordingly, the penetration of the carbon paste can be stopped at an appropriate position inside the porous base material, and the carbon paste is suppressed from passing through the porous base material to penetrate to the back surface of the porous base material, thus preventing the pores of the porous base material from being clogged by the carbon paste.

In the manufacturing apparatus for a gas diffusion layer according to another aspect of the present disclosure, the back roll may be configured to change the conveying direction of the porous base material horizontally supplied such that the front surface is located on the lower side in the direction of gravity and the back surface is located on the upper side in the direction of gravity, upward in a direction opposite to the direction of gravity, and convey the porous base material, the conveying roll may be disposed at a position distant from and above the back roll in the direction of gravity, and may be configured to change the conveying direction of the porous base material conveyed from the back roll along the direction opposite to the direction of gravity toward a direction inverse to the direction in which the porous base material is supplied to the back roll so as to horizontally convey the porous base material, and the coating head may be disposed below the back roll in the direction of gravity, and the blower is disposed between the back roll and the conveying roll.

With this configuration, the coating head, the back roll, the blower, and the conveying roll can be arranged in the direction of gravity. Therefore, the horizontal size of the entire apparatus can be reduced as compared to the case in which the respective components are horizontally arranged. This means that the overall plane of the apparatus, which is occupied to perform all these steps, is reduced.

The manufacturing apparatus for a gas diffusion layer according to another aspect of the present disclosure may further include a control section configured to adjust at least one of a distance from the blowout port of the blower to the back surface of the porous base material, a blowing temperature, or a blowing volume.

With this configuration, in the blower, at least one of the distance from the blowout port to the back surface, the blowing temperature, and the blowing volume is adjusted; therefore, the porous base material can be blown with the gas under the optimal conditions, and it can be more reliably suppressed that the carbon paste passes through the inside of the porous base material to penetrate to the back surface of the porous base material.

In the manufacturing apparatus for a gas diffusion layer according to another aspect of the present disclosure, the conveying section may include a roll configured to change a conveying direction of the porous base material such that the conveying direction is different before and after the carbon paste is coated by the coating section.

With this configuration, the horizontal size of the entire apparatus can be reduced, and a plane on which the apparatus is installed can be reduced.

In the manufacturing apparatus for a gas diffusion layer according to another aspect of the present disclosure, the conveying section may include a back roll having a plurality of openings in an outer peripheral surface of the back roll coming into contact with the back surface of the porous base material, and the blowing section may be configured to send the gas into an inside of the back roll, and inject the gas from the plurality of openings.

With this configuration, against the coating pressure that acts on the carbon paste being coated, the air pressure acts on the porous base material from the back surface of the porous base material in the thickness direction of the porous base material, and thus it is possible to prevent the carbon paste coated from excessively penetrating into the porous base material.

According to above aspects of the present disclosure, it is possible to provide the manufacturing method and the manufacturing apparatus for a gas diffusion layer capable of preventing the carbon paste coated on the front surface of the porous base material from penetrating to the back surface of the porous base material, and also preventing the pores of the porous base material from being clogged by the carbon paste.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1A is an exploded perspective view of a gas diffusion layer manufactured by a manufacturing method and a manufacturing apparatus for a gas diffusion layer according to a first embodiment and a second embodiment of the present disclosure;

FIG. 1B is a sectional view of the gas diffusion layer manufactured by the manufacturing method and the manufacturing apparatus for a gas diffusion layer according to the first embodiment and the second embodiment of the present disclosure;

FIG. 2 is a schematic view showing a configuration of the manufacturing apparatus for a gas diffusion layer according to the first embodiment of the present disclosure;

FIG. 3 is an enlarged schematic view showing a part of the manufacturing apparatus for a gas diffusion layer according to the first embodiment of the present disclosure;

FIG. 4 is a process diagram showing a manufacturing process of the gas diffusion layer according to the first embodiment of the present disclosure;

FIG. 5 is a graph showing a relationship between a coating speed and a viscosity region of a coatable paste in the manufacturing method and the manufacturing apparatus for a gas diffusion layer according to the first embodiment of the present disclosure;

FIG. 6 is a graph showing a relationship between a blowing temperature and an appearance inspection standard of a back surface: NG ratio of the porous base material in the manufacturing method and the manufacturing apparatus for a gas diffusion layer according to the first embodiment of the present disclosure;

FIG. 7 is a schematic view of the manufacturing apparatus for a gas diffusion layer according to the first embodiment of the present disclosure;

FIG. 8A is a schematic view showing an entire configuration of the manufacturing apparatus for a gas diffusion layer according to the second embodiment of the present disclosure;

FIG. 8B is a perspective view of a back roll and a coating mechanism of the manufacturing apparatus for a gas diffusion layer according to the second embodiment of the present disclosure;

FIG. 9A is a perspective view of the back roll of the manufacturing apparatus for a gas diffusion layer according to the second embodiment of the present disclosure;

FIG. 9B is a view showing an example in which the back roll of the manufacturing apparatus for a gas diffusion layer according to the second embodiment is configured by an air turn bar;

FIG. 9C is a view showing an example in which the back roll of the manufacturing apparatus for a gas diffusion layer according to the second embodiment is configured by a suction roll;

FIG. 10A is an enlarged sectional view of the back roll and a coating head of the manufacturing apparatus for a gas diffusion layer according to the second embodiment of the present disclosure;

FIG. 10B is a view showing a state in which a gas is injected from the back roll toward the coating head of the manufacturing apparatus for a gas diffusion layer according to the second embodiment;

FIG. 11 is a table showing states of the front surface and the back surface of the porous base material of the manufacturing apparatus for a gas diffusion layer according to the second embodiment of the present disclosure; and

FIG. 12 is a schematic view showing a configuration of a conventional manufacturing apparatus for a gas diffusion layer.

### DETAILED DESCRIPTION OF EMBODIMENTS

A manufacturing method and a manufacturing apparatus 20 for a gas diffusion layer 11 according to the first embodiment and the second embodiment to which the manufacturing method and the manufacturing apparatus for a gas diffusion layer according to the present disclosure are applied will be described with reference to the drawings. First, a configuration of the gas diffusion layer 11 according to the first embodiment and the second embodiment and a configuration of the manufacturing apparatus 20 according to the first embodiment will be described.

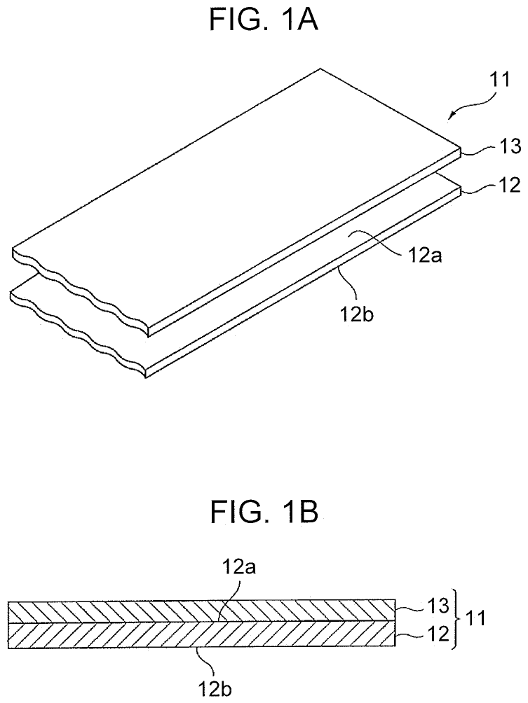

As shown in FIGS. 1A and 1B, the gas diffusion layer 11 according to the first embodiment and the second embodiment includes a sheet porous base material 12 and a carbon paste 13 coated on a front surface that is one surface of the porous base material 12, and is included in a gas diffusion layer (GDL) of a fuel cell. The gas diffusion layer 11 has a function to diffuse and uniformize a hydrogen gas (H₂) and an oxygen gas (O₂) and diffusing the gases across the catalyst layer.

The porous base material 12 is a material having gas permeability and electric conductivity, for example, a porous fiber basic material made of carbon fibers such as carbon paper and carbon cloth and graphite fibers, and formed by a sheet having a predetermined width and thickness.

The carbon paste 13 is configured by a viscous liquid prepared by mixing a predetermined solvent with a water repellent material such as polytetrafluoroethylene (PTFE) and an electric conductive material such as carbon powder. The carbon paste 13 is dried and fired after coating, to thereby form a film having an electric conductivity on the surface of the porous base material 12.

### First Embodiment

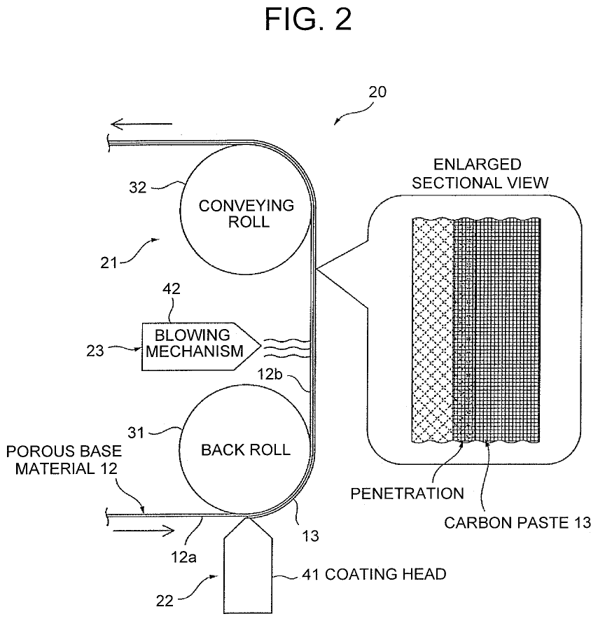

Next, the manufacturing apparatus 20 according to the first embodiment will be described with reference to the drawings. As shown in FIG. 2, the manufacturing apparatus 20 includes: a conveying mechanism (conveying section) 21 for conveying the porous base material 12 and a coating mechanism (coating section) 22 for coating the carbon paste 13 on the porous base material 12; a blowing mechanism (blowing section) 23 for blowing the porous base material 12 with a gas such as air, as air flow; and a not-shown controller (control section) for controlling operation of each component.

The conveying mechanism 21 includes a plurality of rolls for conveying the porous base material 12 while the rolls are in contact with a back surface 12b that is a surface opposite to a front surface 12a of the porous base material 12, and as shown in FIG. 2, the plurality of rolls include a back roll 31 disposed to face the coating mechanism 22 and a conveying roll 32 disposed above the back roll 31 in the direction of gravity. The conveying mechanism 21 is connected to the controller and configured to be controlled by the controller.

The conveying mechanism 21 includes the back roll 31 in contact with the back surface 12b of the porous base material 12 and the conveying roll 32 in contact with the back surface 12b of the porous base material 12 on the downstream side of the back roll 31. The back roll 31 is a roll that conveys the porous base material 12 in different directions before and after the carbon paste 13 is coated by the coating mechanism 22. The back roll 31 changes the conveying direction of the porous base material 12 horizontally supplied such that the front surface 12a of the porous base material 12 is located on the lower side in the direction of gravity and the back surface 12b of the porous base material 12 is located on the upper side in the direction of gravity, upward in a direction opposite to the direction of gravity so as to vertically convey the porous base material 12. The conveying roll 32 is disposed at a position distant from and above the back roll 31 in the direction of gravity. The conveying roll 32 is configured to horizontally convey the porous base material 12 conveyed vertically from the back roll 31 by changing the conveying direction of the porous base material 12 in a direction inverse to the direction in which the porous base material 12 is supplied to the back roll 31.

A conveying speed (m/sec) and a tension (N) of the porous base material 12 in the conveying mechanism 21 are appropriately selected based on respective setting parameters such as a size, a structure, and a material of the porous base material 12, a blowing temperature (° C.), and a blowing volume (m³/min) of blowing from a blowing mechanism 23, and experimental values and data.

The coating mechanism 22 is configured by a known coating mechanism provided with a coating head 41. The known coating mechanism includes, for example, a moving mechanism (not shown) for moving the coating head 41, and a connecting section to which a supply pipe supplied with the carbon paste 13 is connected. The coating mechanism 22 is connected to the controller such that its operation is controlled by the controller.

The coating head 41 includes, for example, an upstream lip located upstream in the conveyance direction of the porous base material 12; a downstream lip located downstream in the conveyance direction of the porous base material 12; a reservoir for storing the carbon paste 13 between the upstream lip and the downstream lip; and a flow passage that allows the carbon paste 13 to flow into the reservoir.

The liquid surface of the carbon paste 13 is exposed to an upper part of the reservoir, and the porous base material 12 is brought into contact with the liquid surface of the carbon paste 13 and is allowed to pass therethrough such that the carbon paste 13 is coated on the front surface 12a of the porous base material 12. The reservoir may be a discharge port that discharges the carbon paste 13 from between the upstream lip and the downstream lip to coat the carbon paste 13 on the front surface 12a of the porous base material 12.

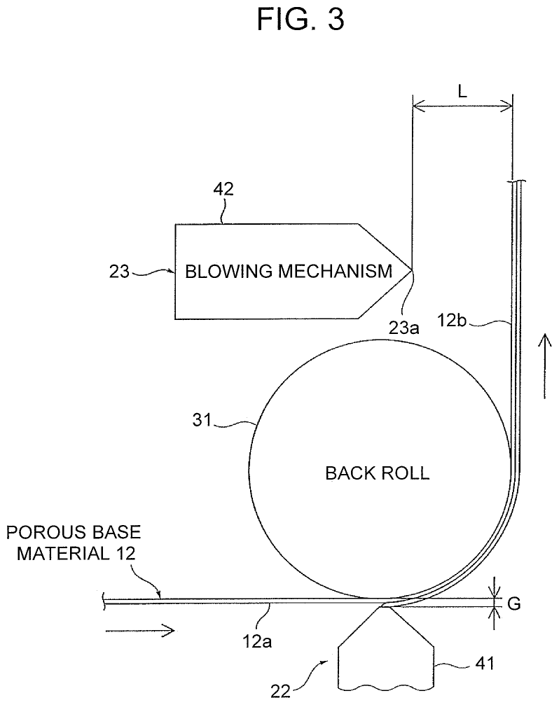

The coating head 41 is disposed on the opposite side of the porous base material 12 from the back roll 31, and in the first embodiment, as shown in FIG. 3, the coating head 41 is disposed below the back roll 31 in the direction of gravity. Between the back roll 31 and the coating head 41, there is formed a coating gap G formed by a clearance gap between an outer peripheral surface of the back roll 31 and the liquid surface of the reservoir or the discharge port.

The coating head 41 is configured to adjust the coating gap G by relatively moving in a direction toward or away from the back roll 31 by the moving mechanism, to thereby adjust a coating amount of the carbon paste 13 to be coated on the front surface 12a of the porous base material 12. With this configuration, it is possible to apply a predetermined amount of the carbon paste 13 on the front surface 12a of the porous base material 12 being conveyed.

The coating amount of the carbon paste 13 to be coated on the front surface 12a of the porous base material 12 is appropriately selected based on the respective setting parameters such as the size, the structure, the material, and the conveying speed of the porous base material 12, and properties of the carbon paste 13, as well as experimental values and data.

The blowing mechanism 23 is disposed between the back roll 31 and the conveying roll 32, and has a blower 42 disposed at a position distant by a predetermined distance from and opposite to the back surface of the porous base material 12 vertically moving. The blower 42 is configured by a known blower for blowing the porous base material 12, and as shown in FIG. 3, is configured to adjust at least one of a distance L (mm) from a blowout port 23a of air flow in a blowing mechanism to the back surface 12b of the porous base material 12, a blowing temperature (° C.), and a blowing volume (m³/min). The blowing mechanism 23 includes a distance adjustment section, a blowing temperature adjustment section, and a blowing volume adjustment section that are not shown, and is connected to the controller such that operation of each section is controlled by the controller.

The space L (mm), the blowing temperature (° C.), and the blowing volume (m³/min) in the blowing mechanism 23 are appropriately selected based on the respective setting parameters such as the size, the structure, and the material of the porous base material 12, and the properties of the carbon paste 13, as well as experimental values and data.

The controller is configured to include a central processing unit that executes an arithmetic processing and a memory that stores a control program, and is connected to the conveying mechanism 21, the coating mechanism 22, and the blowing mechanism 23 so as to control the operation of each component.

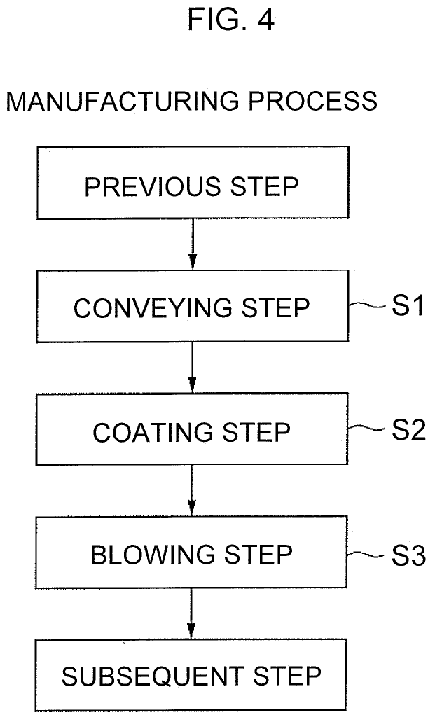

Next, the manufacturing method for the gas diffusion layer 11 according to the first embodiment will be described with reference to the drawings. The manufacturing method for the gas diffusion layer 11 is configured to include a conveying step, a coating step, and a blowing step, as shown in a manufacturing process of FIG. 4, and each step is performed in order.

In the conveying step, as shown in FIG. 2, the porous base material 12 supplied from a previous step, such as a supply step, is conveyed by the conveying mechanism 21 in the horizontal direction orthogonal to the direction of gravity, and the conveying direction of the porous base material 12 is changed substantially at a right angle by the back roll 31 upward in the direction opposite to the direction of gravity so as to vertically convey the porous base material 12. Further, the conveying direction of the porous base material 12 conveyed from the back roll 31 is changed substantially at a right angle by the conveying roll 32, and is conveyed in a conveying direction inverse to the conveying direction of the porous base material 12 supplied from the supply step, and the porous base material 12 is then fed out to a subsequent step, such as a drying step or a baking step (step S1).

In the conveying step, the conveying speed (m/sec) and the tension (N) of the porous base material 12 are selected based on the respective setting parameters such as the size, the structure, and the material of the porous base material 12, the blowing temperature (° C.) and the blowing volume (m³/min) from the blower 42, and experimental values and data. The conveying speed and the tension of the porous base material 12 in the conveying mechanism 21 are controlled by the controller.

In the coating step, the carbon paste 13 is coated on the front surface 12a of the porous base material 12 being conveyed by the coating mechanism 22 (step S2). Specifically, the porous base material 12 is brought into contact with the liquid surface of the liquid carbon paste 13 supplied through the flow passage and stored in the reservoir between the upstream lip and the downstream lip, to thereby coat the carbon paste 13 on the front surface 12a of the porous base material 12.

The coating head 41 disposed on the side facing the back roll 31 with the porous base material 12 interposed therebetween moves relative to the back roll 31 by the moving mechanism, whereby the coating amount of the carbon paste 13 to be coated on the front surface 12a of the porous base material 12 is adjusted. The coating mechanism 22 is connected to the controller so as to be controlled such that the operation of each component, such as the moving mechanism of the coating head 41, is controlled.

In the blowing step, as shown in FIG. 3, depending on the porous base material 12, the blowing mechanism 23 is set with an optimal distance L (mm) from the blowout port 23a of the air flow to the back surface 12b of the porous base material 12. Furthermore, the blowing mechanism 23 is also set at an optimal blowing temperature (° C.) and with an optimal blowing volume (m³/min) in the blowing mechanism 23. In the condition where the optimal values are set, air as a gas is injected onto the back surface 12b of the porous base material 12 from the blowout port 23a (step S3).

Based on the control of the controller, the optimal distance L is adjusted by the distance adjustment section of the blowing mechanism 23; the optimal blowing temperature is adjusted by the blowing temperature control section of the blowing mechanism 23; and the optimal blowing volume is adjusted by the blowing volume adjustment section of the blowing mechanism 23. The optimal distance L, and the optimal blowing temperature and blowing volume are appropriately selected based on the respective setting parameters such as the size, the structure, and the material of the porous base material 12, and the properties of the carbon paste 13, as well as experimental values and data.

With respect to the gas diffusion layer 11 produced by the manufacturing method and the manufacturing apparatus 20 for the gas diffusion layer 11 according to the first embodiment, conditions of penetration to the back surface 12b of the porous base material 12 coated with the carbon paste 13 were observed, and a defect ratio, that is, an NG ratio of the gas diffusion layer 11 was verified.

An NG ratio means a percentage, relative to a total number of gas diffusion layers 11 produced, of the number of gas diffusion layers 11 in each of which the carbon paste 13 coated on the front surface 12a of the porous base material 12 passes through the inside of the porous base material 12, and penetrates to the back surface 12b of the porous base material 12, to clog the pores of the porous base material 12, which means a percentage of the number of gas diffusion layers 11 in which strikethrough occurs, so that the gas diffusion layers 11 are determined as defective products. That is, the NG ratio is expressed as follows: the NG ratio=the number of defective products/the total number of finished products.

In addition, the inspection standard indicating a standard of a defective product is defined by an in-plane adhesion area of 9 mm² or less. That is, with respect to an in-plane adhesion area which means an area where strikethrough occurs and the carbon paste 13 adheres to the back surface 12b, on the back surface 12b of the porous base material 12, if a product of interest has an in-plane adhesion area of 9 mm² or less, it is determined that this product satisfies the standard; and if a product of interest has an in-plane adhesion area of more than 9 mm², it is determined that this product does not satisfies the standard. A target of the NG ratio is set at 0.2% or less. The verification will be described in detail as below.

Each gas diffusion layer 11 as a verification target was produced by the manufacturing method and the manufacturing apparatus 20 for the gas diffusion layer 11 according to the first embodiment. The porous base material 12 included in the gas diffusion layer 11 had a thickness of 100 μm to 200 μm and a density of 300 mg/cm³ to 450 mg/cm³. As the carbon paste 13 coated on the front surface 12a of the porous base material 12, a carbon paste, having a viscosity of 200 mPa·s to 600 mPa·s and formed of carbon powder made of an electric conductive material with a solid content of 12% to 15%, was used.

Coating of the carbon paste 13 on the porous base material 12 by the coating mechanism 22 was performed under the following conditions. The coating was performed under the conditions as follows: the coating speed, that is, the conveying speed of the porous base material 12 by the conveying mechanism 21 was 10 m/min; the coating gap G shown in FIG. 3 was 250 μm to 350 μm; the weight per unit area of the carbon paste 13 coated on the front surface 12a of the porous base material 12, that is, the coating basis weight was 3 mg/cm² to 4 mg/cm²; and the conveyance tension of the porous base material 12 by the conveying mechanism 21 was 60 N.

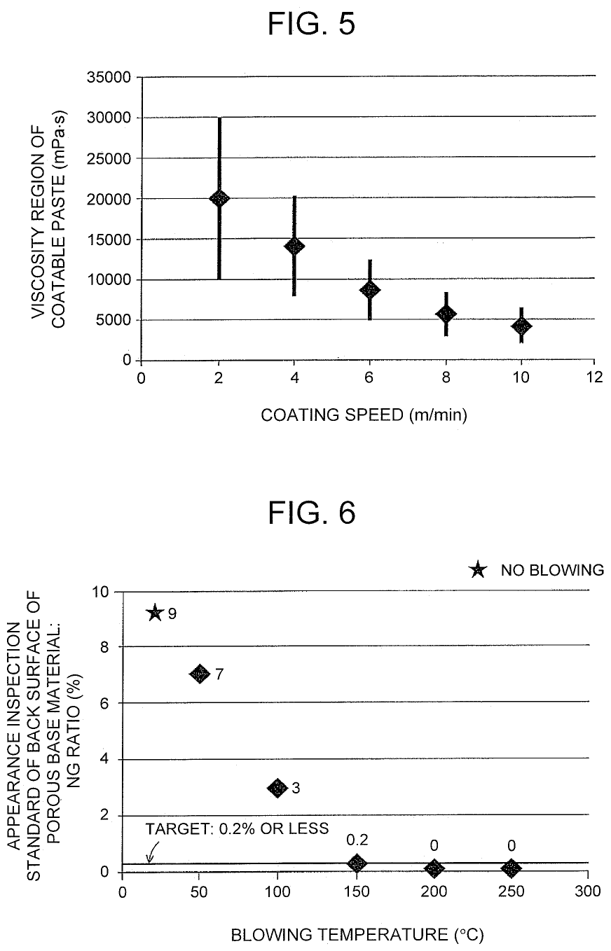

A relationship between the coating speed (m/min) and the viscosity of the carbon paste 13 coatable, that is, a relationship between the coating speed and the viscosity region of the coatable paste is shown in a graph of FIG. 5. As shown in the graph, when the coating speed is 10 m/min, the viscosity region of the coatable paste is 200 mPa·s to 600 mPa·s. As shown in the graph, there is such a relationship between the coating speed and the viscosity of coatable carbon paste that as the coating speed becomes higher, the width of the viscosity region of coatable paste becomes narrower, and the viscosity itself becomes lower at the same time.

The blowing to the back surface 12b of the porous base material 12 was performed by the blowing mechanism 23 under the following conditions. That is, the blowing was performed with no blowing and with blowing (in the case with the blowing, the blowing temperature was set at 50° C., 100° C., 150° C., 200° C., and 250° C.), respectively.

Hereinafter, there was found the NG ratio based on the appearance inspection standard of the back surface 12b of the porous base material 12, in relation with the blowing temperature. The appearance inspection was performed in such a manner that the back surface 12b of the porous base material 12 was imaged with a known surface observation camera or the like including an imaging device such as a CCD (charge coupled device) image sensor and a CMOS (complementary metal oxide semiconductor) image sensor. Note that equipment for carrying out the apparent inspection may be any type of equipment other than a surface observation camera as far as this equipment can inspect the appearance of the back surface 12b of the porous base material 12.

As shown in FIG. 6, in the case with no blowing as represented by a mark “★”, the NG ratio was 9%, which did not meet the target of 0.2%. In the case with the blowing temperature of 50° C., the NG ratio was 7%, which did not meet the target of 0.2%. In the case with the blowing temperature of 100° C., the NG ratio was 3%, which did not meet the target of 0.2%. In the case with the blowing temperature of 150° C., the NG ratio was 0.2%, which met the target of 0.2%. In the case with the blowing temperature of 200° C. and 250° C., the NG ratio was about 0.1%, which met the target of 0.2%.

Therefore, it is found that, when the blowing temperature is 150° C., 200° C. and 250° C., that is, the blowing temperature is 150° C. or more and 250° C. or less, the NG ratio is 0.2% or less, which meets the target of 0.2%.

As the viscosity (mPa·s) of the carbon paste 13 is lower, its fluidity becomes higher, and thus the carbon paste 13 coated on the front surface 12a of the porous base material 12 more easily penetrates into the back surface 12b; therefore strikethrough is more likely to occur. In this verification, the viscosity region of the coatable paste of the carbon paste 13 is set at 200 mPa·s to 600 mPa·s, which is a relatively low viscosity. Therefore, in the manufacturing method and the manufacturing apparatus 20 for the gas diffusion layer 11 according to the first embodiment, it is confirmed that the target NG ratio of 0.2% is satisfied even if the carbon paste 13 has a relatively low viscosity.

In the gas diffusion layer 11 according to the present verification, the carbon paste 13 can have a relatively low viscosity of 200 mPa·s to 600 mPa·s, and even if such a high-speed coating at 10 m/min is carried out, it is confirmed that the target NG ratio 0.2% is satisfied; thus, it is also confirmed that productivity can be promoted with a high-speed coating.

Effects of the manufacturing method and the manufacturing apparatus 20 for the gas diffusion layer 11 according to the first embodiment as above configured will be explained.

The manufacturing method for the gas diffusion layer 11 according to the first embodiment is configured to include: the conveying step (step S1) for conveying the porous base material 12; the coating step (step S2) of coating the carbon paste 13 on the front surface 12a of the porous base material 12 being conveyed; and the blowing step (step S3) of blowing the back surface 12b of the porous base material 12 coated with the carbon paste 13 with air.

With this configuration, the porous base material 12 is conveyed in the conveying step, and the carbon paste 13 is coated on the front surface 12a of the porous base material 12 being conveyed in the coating step, and after the coating of the carbon paste 13, in the blowing step, air is injected onto the back surface 12b of the porous base material 12 coated with the carbon paste 13.

The carbon paste 13 coated on the front surface 12a of the porous base material 12 penetrates from the front surface 12a into the inside of the porous base material 12 by capillary action. However, since the back surface 12b of the porous base material 12 is blown with the air in the blowing step, the carbon paste 13 receives a force in the direction opposite to the direction of the penetration, so that it becomes difficult for the carbon paste 13 to move in the direction of its penetration, and at the same time, drying of the carbon paste is promoted from the side of the back surface 12b of the porous base material 12, thus suppressing the penetration of the carbon paste 13 into the porous base material 12. Accordingly, the following effect can be obtained that the penetration of the carbon paste 13 can be stopped at an appropriate position inside the porous base material 12; and the carbon paste 13 is suppressed from passing through the porous base material 12 and penetrating to the back surface 12b of the porous base material 12, thus preventing the pores of the porous base material 12 from being clogged by the carbon paste 13.

The manufacturing method for the gas diffusion layer 11 according to the first embodiment includes the conveying step (S1) of moving the porous base material 12 by bringing the rolls 31 and 32 into contact with the back surface 12b of the porous base material 12, and the coating step (S2) and the blowing step (S3) are carried out on the porous base material 12 being moved in the conveying step (S1). With this configuration, since the coating on the front surface 12a of the porous base material 12 and the blowing of the back surface 12b are performed while the porous base material 12 is being moved, such an effect that facilitates the manufacturing of the gas diffusion layer 11 in a shorter time can be obtained.

In the manufacturing method for the gas diffusion layer 11 according to the first embodiment, in the conveying step (S1), the porous base material 12 is conveyed in such a manner that, in at least a part of the porous base material 12, the front surface 12a of the porous base material 12 is located on the lower side in the gravity direction, and the back surface 12b thereof is located on the upper side in the gravity direction; and in the coating step (S2), the coating is carried out on the front surface 12a of the porous base material 12 located on the lower side in the gravity direction.

With this configuration, gravity acts on the carbon paste 13 coated on the front surface 12a of the porous base material 12, and the carbon paste 13 receives a force in the direction opposite to the direction of penetrating into the inside of the porous base material 12, and thus the carbon paste 13 becomes difficult to move in the penetrating direction, thereby suppressing the penetration of the carbon paste 13 into the porous base material 12. Therefore, the following effects can be obtained that the penetration of the carbon paste 13 can be stopped at an appropriate position inside the porous base material 12, the carbon paste 13 is suppressed from penetrating through the porous base material 12 to reach the back surface 12b of the porous base material 12, and the pores of the porous base material 12 can be prevented from being clogged by the carbon paste 13.

In the manufacturing method for the gas diffusion layer 11 according to the first embodiment, in the conveying step (S1), the conveying direction of the porous base material 12, being horizontally conveyed in such a manner that the front surface 12a of the porous base material 12 is located on the lower side in the direction of gravity and the back surface 12b is located on the upper side in the direction of gravity, is changed upward in the direction opposite to the direction of gravity so as to vertically convey the porous base material 12; in the coating step (S2), the coating is performed on the front surface 12a of the porous base material 12 being horizontally conveyed; and in the blowing step (S3), the back surface 12b of the porous base material 12 being vertically conveyed is blown with air. This configuration allows the conveying step (S1), the coating step (S2), and the blowing step (S3) to be vertically arranged to overlap one another. Therefore, the size of the entire apparatus can be reduced as compared to the case in which the respective steps are horizontally arranged side by side. This means that an overall plane of the apparatus, which is occupied to perform all these steps, is reduced.

The manufacturing apparatus for the gas diffusion layer 11 according to the first embodiment includes: the conveying mechanism 21 configured to convey the porous base material 12; the coating mechanism 22 configured to coat the carbon paste 13 on the front surface 12a of the porous base material 12 being conveyed by the conveying mechanism 21; and the blowing mechanism 23 configured to inject air onto the back surface 12b of the porous base material 12 having the front surface 12a coated with the carbon paste 13 by the coating mechanism 22.

With this configuration, the carbon paste 13 coated by the coating head 41 on the surface 12a of the porous base material 12 penetrates into the inside of the porous base material 12 from the front surface 12a by capillary action. However, since the air is injected onto the back surface 12b of the porous base material 12 by the blowing mechanism 23, the carbon paste 13 receives a force in the direction opposite to the direction in which the carbon paste 13 penetrates, so that it becomes difficult for the carbon paste 13 to move in the penetrating direction. Due to this, the drying of the carbon paste 13 is promoted from the side of the back surface 12b of the porous base material 12, and the penetration into the porous base material 12 is thus suppressed. Accordingly, the following effects can be obtained that the penetration of the carbon paste 13 is stopped at an appropriate position inside the porous base material 12, the carbon paste 13 is suppressed from penetrating through the porous base material 12 to reach the back surface 12b of the porous base material 12, and the pores of the porous base material 12 is prevented from being clogged by the carbon paste 13.

In the manufacturing apparatus for the gas diffusion layer 11 according to the first embodiment, the conveying mechanism 21 includes the back roll 31 in contact with the back surface 12b of the porous base material 12, and the conveying roll 32 in contact with the back surface 12b of the porous base material 12 on the downstream side of the back roll 31 in the conveying direction of the porous base material 12; the coating mechanism 22 has the coating head 41 disposed at a position facing the back roll 31 with the porous base material 12 interposed therebetween; and the blowing mechanism 23 has a blower disposed to face the back surface 12b of the porous base material 12 at a position between the back roll 31 and the conveying roll 32. With this configuration, the back roll 31 and the conveying roll 32 are brought into contact with the back surface 12b of the porous base material 12 to convey the porous base material 12 from the back roll 31 to the conveying roll 32, the carbon paste 13 is coated on the surface of the porous base material 12 by the coating head 41 disposed to face the back roll 31 with the porous base material 12 interposed therebetween, and the back surface 12b of the porous base material 12 is blown with air at a position between the back roll 31 and the conveying roll 32.

Therefore, while the carbon paste 13, after being coated on the front surface 12a of the porous base material 12 by the coating head 41, penetrates into the inside of the porous base material 12 from the front surface 12a of the porous base material 12 by capillary action, the back surface 12b of the porous base material 12 is blown with air. Therefore, the carbon paste 13 receives a force in the direction opposite to the direction in which the carbon paste 13 penetrates, so that it becomes difficult for the carbon paste 13 to move in the penetrating direction, and at the same time, the drying of the carbon paste 13 is promoted from the back surface 12b side of the porous base material 12, and thus the penetration into the porous base material 12 is suppressed. Accordingly, the penetration of the carbon paste 13 can be stopped at an appropriate position inside the porous base material 12, the carbon paste 13 can be suppressed from penetrating through the porous base material 12 to reach the back surface of the porous base material 12, and the pores of the porous base material 12 can be prevented from being clogged by the carbon paste 13.

In the manufacturing apparatus for the gas diffusion layer according to the first embodiment, the back roll 31 changes the conveying direction of the porous base material 12, being horizontally supplied in such a manner that the front surface 12a of the porous base material 12 is located on the lower side in the direction of gravity and the back surface 12b thereof is located on the upper side in the direction of gravity, upward in the direction opposite to the direction of gravity so as to vertically convey the porous base material 12; the conveying roll 32 is disposed at a position distant from and above the back roll 31 in the direction of gravity, and changes the conveying direction of the porous base material 12 being vertically conveyed from the back roll 31 in a direction inverse to the direction in which the porous base material 12 is supplied to the back roll 31 so as to horizontally convey the porous base material 12; the coating head 41 is disposed below the back roll 31 in the direction of gravity; and the blowing mechanism 23 is disposed between the back roll 31 and the conveying roll 32.

With this configuration, the coating head 41, the back roll 31, the blowing mechanism 23, and the conveying roll 32 can be arranged along the gravity direction. Therefore, the horizontal size of the entire apparatus can be reduced as compared to the case in which the respective components are horizontally arranged. That is, the overall plane of the apparatus occupied to perform all these steps is reduced.

The manufacturing apparatus for the gas diffusion layer according to the first embodiment includes the control section that adjusts at least one of the distance from the blowout port of the blowing mechanism 23 to the back surface 12b of the porous base material 12, the blowing temperature, and the blowing volume. With this configuration, at least one of the distance from the blowout port of the blowing mechanism 23 to the back surface 12b of the porous base material 12, the blowing temperature, and the blowing volume is adjusted. Accordingly, the back surface 12b of the porous base material 12 can be blown with air under the optimal conditions, and it can be more reliably suppressed that the carbon paste 13 penetrates to the back surface 12b of the porous base material 12.

In the manufacturing apparatus for the gas diffusion layer according to the first embodiment, the conveying mechanism 21 includes the back roll 31 that changes the conveying direction of the porous base material 12 in different directions between before and after the carbon paste 13 is coated by the coating mechanism 22. This configuration can reduce the horizontal size of the entire apparatus, and the plane on which the apparatus is installed can be reduced.

It has been exemplified that the manufacturing apparatus 20 for the gas diffusion layer 11 according to the first embodiment is configured by adopting the structure in which the conveying roll 32 of the conveying mechanism 21 is arranged above the back roll 31 in the direction of gravity, as shown in FIG. 2. The manufacturing apparatus for the gas diffusion layer according to the present disclosure may be configured by adopting a structure other than the structure in which the conveying roll of the conveying mechanism is arranged above the back roll in the direction of gravity.

Hereinafter, a manufacturing apparatus 20A for the gas diffusion layer 11 according to a modification configured by adopting a structure other than the structure in which the conveying roll of the conveying mechanism is arranged above the back roll in the direction of gravity will be described with reference to the drawings.

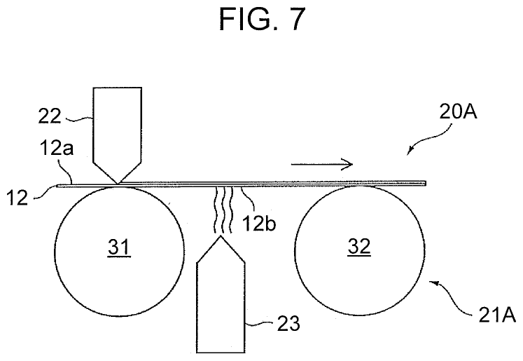

As shown in FIG. 7, the manufacturing apparatus 20A for the gas diffusion layer 11 according to the modification includes a conveying mechanism 21A, the coating mechanism 22, and the blowing mechanism 23, as in the first embodiment, and the conveying mechanism 21A includes the back roll 31 and the conveying roll 32. The back roll 31 is disposed on the left side in the paper surface of the drawing, and the conveying roll 32 is disposed on the horizontally downstream side of the back roll 31 in the conveyance direction indicated by an arrow. With this configuration, the porous base material 12 supplied from the supply mechanism is conveyed in the horizontal direction.

The coating mechanism 22 is disposed above the back roll 31 in the direction of gravity with the porous base material 12 interposed therebetween, and the blowing mechanism 23 is disposed below the porous base material 12 in the direction of gravity. The blowing mechanism 23 is configured to blow the back surface 12b from below the porous base material 12.

In the manufacturing apparatus 20A for the gas diffusion layer 11 according to the modification, although the arrangement space of the manufacturing apparatus 20A is longer, the same effect as that of the manufacturing apparatus 20 for the gas diffusion layer 11 according to the first embodiment can be obtained. That is, such an effect can be obtained that the carbon paste 13 coated on the front surface 12a of the porous base material 12 does not penetrate to the back surface 12b of the porous base material 12, and thus the pores of the porous base material 12 are prevented from being clogged by the carbon paste 13.

In addition, it has been exemplified that the manufacturing method by using the manufacturing apparatus 20 for the gas diffusion layer 11 according to the first embodiment is configured by adopting the structure in which the blowing mechanism 23 is arranged between the back roll 31 and the conveying roll 32. However, in the manufacturing apparatus for the gas diffusion layer according to the present disclosure, it may be configured that a structure other than the structure in which the blowing mechanism 23 is arranged between the back roll 31 and the conveying roll 32 may be adopted.

For example, the blowing mechanism of the manufacturing apparatus for the gas diffusion layer according to the present disclosure may be configured such that air is injected as air flow from the inside of the back roll toward the back surface of the porous base material opposite to the front surface thereof on which the coating is being performed.

Hereinafter, a manufacturing apparatus 20B for the gas diffusion layer 11 according to the second embodiment will be described with reference to drawings, and in the manufacturing apparatus 20B for the gas diffusion layer 11, the blowing mechanism is configured by a structure of injecting air from the inside of the back roll toward the back surface of the porous base material opposite to the front surface thereof on which the coating is being performed.

### Second Embodiment

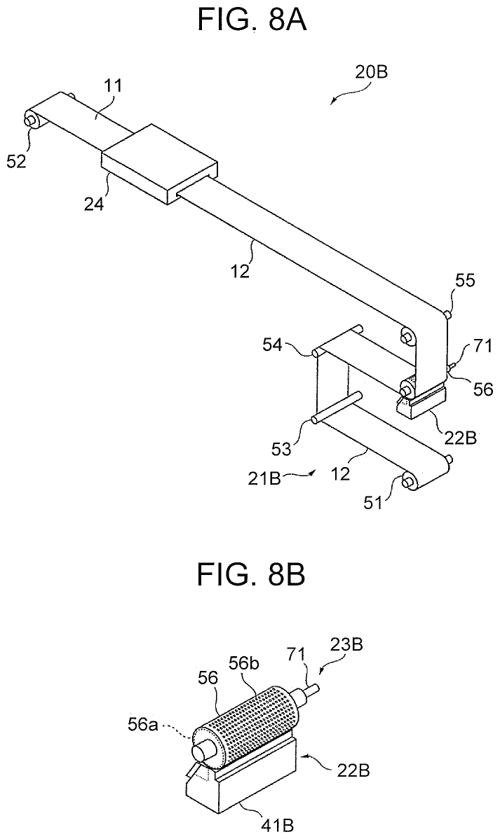

As shown in FIG. 8A and FIG. 8B, the manufacturing apparatus 20B for the gas diffusion layer 11 according to the second embodiment includes: a conveying mechanism (conveying section) 21B for conveying the belt shape porous base material 12; a coating mechanism (coating section) 22B for coating the carbon paste 13 on the front surface 12a of the porous base material 12; a blowing mechanism (blowing section) 23B for blowing the back surface 12b of the porous base material 12 with air; a firing furnace 24; and a controller (control section) that controls operation of each component. The carbon paste 13 may be a microporous (MPL: micro porous layer) paste.

The conveying mechanism 21B includes an unwinding mechanism 51, a winding mechanism 52, conveying rolls 53, 54, 55, and a back roll 56. The conveying mechanism 21B is connected to the controller, and the operation is controlled by the controller.

The unwinding mechanism 51 is connected to a drive mechanism (not shown), and has a configuration to unwind the porous base material 12 wound in a roll form and feed out the porous base material 12 toward the conveying roll 53. The winding mechanism 52 is connected to a drive mechanism (not shown), and is configured to wind up the belt shape gas diffusion layer 11 formed by coating the carbon paste 13 on the front surface 12a of the porous base material 12 by the coating mechanism (coating section) 22B, and then firing this porous base material 12 by the firing furnace 24.

The conveying roll 53 and the conveying roll 54 are both disposed between the unwinding mechanism 51 and the back roll 56, and have a configuration to change the conveying direction of the porous base material 12 at 180 degrees so as to guide the porous base material 12 in a direction from the unwinding mechanism 51 toward the back roll 56.

The conveying roll 55 is distant from and above the back roll 56 in the direction of gravity. The conveying roll 55 changes the direction of the coated porous base material 12 vertically fed out from the back roll 56 toward a direction inverse to the direction in which the porous base material 12 is fed to the back roll 56 so as to horizontally convey the porous base material 12 toward the firing furnace 24.

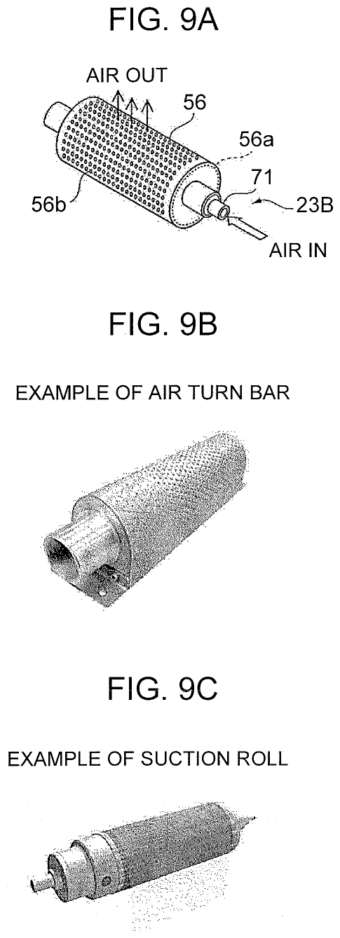

As shown in FIG. 8B and FIG. 9A, the back roll 56 is disposed to face the coating mechanism 22B, and has a structure that conveys the porous base material 12 in different conveying directions before and after the carbon paste 13 is coated on the porous base material 12 by the coating mechanism 22B. Specifically, the back roll 56 is configured to change the conveying direction of the porous base material 12, horizontally supplied such that the front surface 12a is located on the lower side in the direction of gravity and the back surface 12b is located on the upper side in the direction of gravity, upward in the direction opposite to the direction of gravity so as to vertically convey the porous base material 12.

The back roll 56 is formed by a hollow cylinder having a wall 56a with a predetermined thickness, and one axial end of back roll 56 is closed and the other axial end thereof is connected to the blowing mechanism 23B. The back roll 56 is connected to a drive mechanism (not shown) on the other end side, and is rotationally driven by the drive mechanism.

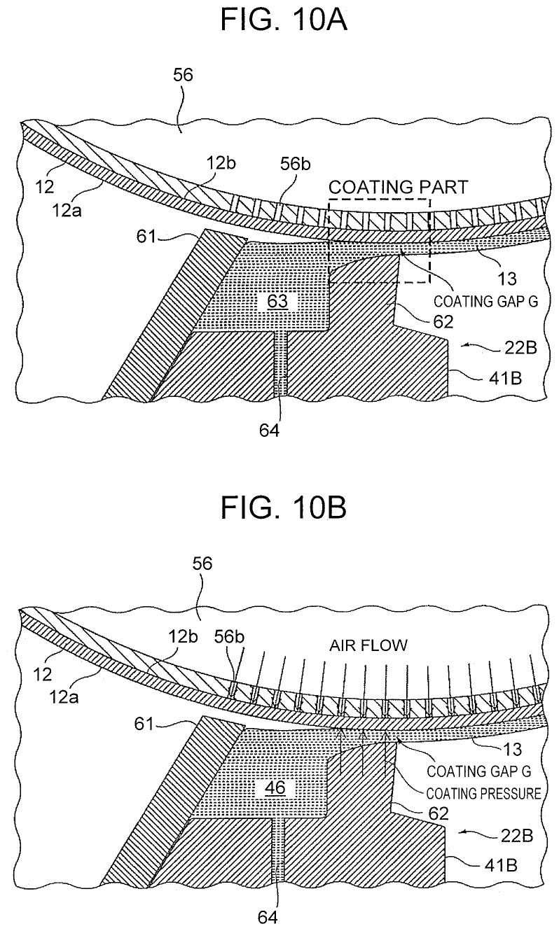

The back roll 56 is configured to take air supplied from the blowing mechanism 23B into the inside thereof, inject the air from a plurality of blowout ports (openings) 56b penetrating through the wall 56a and opening to an outer peripheral surface of the back roll 56, as shown in FIG. 10A and FIG. 10B, and blow the back surface 12b of the porous base material 12 with the air.

The plurality of blowout ports 56b are formed with equal intervals throughout the entire range of 360 degrees around the outer peripheral surface of the back roll 56. The back roll 56 in the present embodiment rotates together with the porous base material 12 with the porous base material 12 in contact with the outer peripheral surface of the back roll 56; thus, abrasion does not occur between the back roll 56 and the porous base material 12.

As aforementioned, the back roll 56 is formed by a hollow cylinder having the wall 56a with a predetermined thickness, and is configured such that one axial end of the back roll 56 is closed and the other axial end thereof is connected to the blowing mechanism 23B; and the back roll 56 may rotate or may not rotate as far as the back surface 12b of the porous base material 12 is blown with the air from the plurality of blowout ports 56b penetrating through the wall 56a.

For example, the back roll 56 may be an air turn bar that is un-rotatable, as shown in FIG. 9B, or may be a suction roll that is rotatable, as shown in FIG. 9C. The air turn bar has a semi-circular or a semi-elliptical cross section, and flanges are fixed at both axial ends thereof, and a joint for providing a compressed air supply is connected on one side or both sides of the air turn bar. The air turn bar has a plurality of through holes in the outer peripheral surface, and is configured to discharge air from the through holes. The suction roll is formed by a hollow cylinder, and a plurality of through holes are formed in the outer peripheral surface thereof. The suction roll has a structure to suck the inside by a suction box connected to one side or both sides of the suction roll. Conversely, air can be supplied from the suction box and injected from the through holes formed in the outer peripheral surface of the suction box; thus, the suction box can also be used as a back roll.

In addition, the back roll 56 may have a structure other than a roll shape, for example, may have a flat shape. In the case of adopting a structure with a flat shape, it is possible to increase a length where the front surface 12a of the porous base material 12 comes into contact with the liquid surface of the carbon paste 13 stored in the coating mechanism 22B, that is, a contact length thereof, to thereby promote stabilization of the coating.

In the conveying mechanism 21B, the conveying speed (m/sec) and the tension (N) of the porous base material 12 are appropriately selected based on the respective setting parameters such as the size, the structure, and the material of the porous base material 12, the blowing temperature (° C.), and the blowing volume (m³/min) of blowing from the blowing mechanism 23, as well as experimental values and data.

The coating mechanism 22B is configured by a coating mechanism provided with a coating head 41B. The coating mechanism 22B includes, for example, a moving mechanism (not shown) that moves the coating head 41B, and a connecting section to which a supply pipe supplied with the carbon paste 13 is connected. The coating mechanism 22B is connected to the controller, and its operation is controlled by the controller.

As shown in FIG. 10A, the coating head 41B includes: an upstream lip 61 located upstream in the conveying direction of the porous base material 12; a downstream lip 62 located downstream in the conveying direction; a reservoir 63 that stores the carbon paste 13 between the upstream lip 61 and the downstream lip 62; and a flow passage 64 that allows the carbon paste 13 to flow into the reservoir 63.

The liquid surface of the carbon paste 13 is exposed to an upper part of the reservoir 63, and the porous base material 12 is brought into contact with the liquid surface of the carbon paste 13 and is allowed to pass therethrough such that the carbon paste 13 is coated on the front surface 12a of the porous base material 12. The reservoir 63 may be a discharge port configured to discharge the carbon paste 13 from between the upstream lip 61 and the downstream lip 62 so as to coat the carbon paste 13 on the surface 12a of the porous base material 12.

The coating head 41B is disposed at a position facing the back roll 31 with the porous base material 12 interposed therebetween, and in the second embodiment, as shown in FIG. 8, the coating head 41B is disposed below the back roll 56 in the direction of gravity. Between the back roll 56 and the coating head 41B, as shown to FIG. 10A and FIG. 10B, the coating gap G configured by a clearance gap between the outer peripheral surface of the back roll 56 and the downstream lip 62 is formed.

The coating gap G between the outer peripheral surface of the back roll 56 and the downstream lip 62 can be adjusted by relatively moving the coating head 41B in a direction toward or away from the back roll 56 by the moving mechanism, and thus a coating pressure of the carbon paste 13 to be coated on the front surface 12a of the porous base material 12 can be adjusted. Increase or decrease in coating amount of the carbon paste 13 can be adjusted by moving the upstream lip 61 in a direction toward or away from the back roll 56. With this configuration, it is possible to coat a predetermined amount of the carbon paste 13 at a predetermined coating pressure on the front surface 12a of the porous base material 12 being conveyed.

The coating amount of the carbon paste 13 to be coated onto the front surface 12a of the porous base material 12 is appropriately selected based on the respective setting parameters such as the size, the structure, the material, and the conveyance speed of the porous base material 12, and the properties of the carbon paste 13, as well as experimental values and data.

As shown in FIG. 9A, the blowing mechanism 23B includes an air supply pipe 71 and an air supply mechanism (not shown). One end of the air supply pipe 71 connects the other end of the back roll 56 and the air supply mechanism so as to supply the air supplied from the air supply mechanism to the inside of the back roll 56.

The air supply mechanism is configured to supply air into the back roll 56 via the air supply pipe 71 and inject the air from the plurality of blowout ports 56b of the back roll 56. At least one of the temperature (° C.) and the supply volume (m³/min) of the air supplied into the back roll 56 can be adjusted. The blowing mechanism 23B includes an air temperature adjustment section and a supply volume adjustment section that are not shown, and the controller controls operation of each section.

In addition, the temperature (° C.) and the supply volume (m³/min) of the air in the blowing mechanism 23B are appropriately selected based on the respective setting parameters such as the size, the structure, and the material of the porous base material 12, and the properties of the carbon paste 13, as well as experimental values and data.

The controller includes a central processing unit that performs arithmetic processing and a memory that stores a control program, and is connected to the conveying mechanism 21B, the coating mechanism 22B, and the blowing mechanism 23B so as to control operation of each component.

During the conveyance by the conveying mechanism 21B, the firing furnace 24 is configured to heat the porous base material 12 after being subjected to the coating by the coating mechanism 22B so as to perform drying and firing on the porous base material 12 after being subjected to the coating. The porous base material 12 is dried and fired by the firing furnace 24, to thereby finish the gas diffusion layer 11.

Next, the manufacturing method for the gas diffusion layer 11 according to the second embodiment will be described with reference to the drawings. The manufacturing method for the gas diffusion layer 11 according to the second embodiment is performed in the same manner as the manufacturing method for the gas diffusion layer 11 according to the first embodiment; thus, description thereof will be provided with reference to the diagram of the process as shown in FIG. 4. The manufacturing method for the gas diffusion layer 11 according to the second embodiment is configured to include the conveying step, the coating step, and the blowing step as shown in the manufacturing process in FIG. 4, and each step is performed in order.

In the conveying step, as shown in FIG. 8A, subsequent to a previous step such as setting the porous base material 12 to the unwinding mechanism 51 and setting the gas diffusion layer 11 to the winding mechanism 52, the porous base material 12 is unwound from the unwinding mechanism 51, and the conveyance thereof in the horizontal direction orthogonal to the direction of gravity is started. The conveying direction of the porous base material 12 is changed via the conveying rolls 53 and 54 so as to convey the porous base material 12 toward the back roll 56.

The conveying direction of the porous base material 12 is changed at a substantially right angle by the back roll 56 upward in the direction opposite to the gravity direction so as to vertically convey the porous base material 12. Then, the conveying direction of the porous base material 12 conveyed from the back roll 56 is changed at a substantially right angle by the conveying roll 55 so as to convey the porous base material 12 in the same direction as the conveying direction of the porous base material 12 unwound from the unwinding mechanism 51. Further, the porous base material 12 passes through the firing furnace 24 to become the gas diffusion layer 11, and is then conveyed to the winding mechanism 52 (step S1).

In the conveying step, based on the respective parameters such as the size, the structure, and the material of the porous base material 12, and the temperature (° C.) and the supply volume (m³/min) of air supplied from the blowing mechanism 23B, as well as experimental values and data, the conveying speed (m/sec) and the tension (N) of the porous base material 12 are selected. The conveying speed and the tension of the porous base material 12 in the conveying mechanism 21B are controlled by the controller.

In the coating step, the carbon paste 13 is coated on the front surface 12a of the porous base material 12 being conveyed by the coating mechanism 22B (step S2). Specifically, the carbon paste 13 is coated on the front surface 12a of the porous base material 12 by bringing the porous base material 12 into contact with the liquid surface of the liquid carbon paste 13 supplied via the flow passage 64 and stored in the reservoir 63 between the upstream lip 61 and the downstream lip 62.

The coating gap G between the downstream lip 62 and the back roll 56 can be adjusted by relatively moving the coating head 41B disposed on the opposite side of the porous base material 12 from the back roll 56 in a direction toward or away from the back roll 56 by the moving mechanism, and thus a coating pressure of the carbon paste 13 to be coated on the front surface 12a of the porous base material 12 can be adjusted. In addition, the coating amount of the carbon paste 13 to be coated on the surface 12a of the porous base material 12 is adjusted by relatively moving the upstream lip 61 in a direction toward or away from the back roll 56. The coating mechanism 22B is connected to the controller, and the controller controls operation of each component such as the moving mechanism of the coating head 41B.

In the blowing step, as shown in FIG. 10B, the blowing mechanism 23B injects air from the plurality of blowout ports 56b of the back roll 56 toward the back surface 12b of the porous base material 12. Furthermore, the temperature (° C.) and the supply volume (m³/min) of the air in the blowing mechanism 23B are adjusted to optimal values. In the conditions where these optimal values are adjusted, the blowing to the back surface 12b of the porous base material 12 from the blowout ports 56b is maintained (step S3).

Based on the control of the controller, the optimal air temperature is adjusted by a blowing temperature control section of the blowing mechanism 23B, and the optimal supply volume of the air is adjusted by the supply volume adjustment section of the blowing mechanism 23B. The optimal temperature and supply volume of the air are appropriately selected based on the respective setting parameters such as the size, the structure, and the material of the porous base material 12, and the properties of the carbon paste 13, as well as experimental values and data.

Subsequently, during the conveyance by the conveying mechanism 21B, the coated porous base material 12 is dried and fired in the firing furnace 24 by heating the porous base material 12 after being subjected to the coating by the coating mechanism 22B. The gas diffusion layer 11 finished after the firing step is wound up in a roll by the winding mechanism 52. The gas diffusion layer 11 wound up in a roll is fed to the subsequent step.

Effects of the manufacturing method and the manufacturing apparatus 20B for the gas diffusion layer 11 according to the second embodiment as configured above will be described.

The manufacturing method for the gas diffusion layer 11 according to the second embodiment includes: the conveyance step of conveying the porous base material 12 (step S1); the coating step of coating the carbon paste 13 on the front surface 12a of the porous base material 12 being conveyed (step S2); and the blowing step (step S3) of blowing the back surface 12b of the porous base material 12 on which the carbon paste 13 is coated with air from the plurality of blowout ports 56b of the back roll 56.

With this configuration, the porous base material 12 is conveyed in the conveying step; the carbon paste 13 is coated on the front surface 12a of the porous base material 12 being conveyed in the coating step; the air is injected from the plurality of blowout ports 56b of the back roll 56 toward the back surface 12b of the porous base material 12 coated with the carbon paste 13 in the blowing step. As a result, the air is injected from the plurality of blowout ports 56b of the back roll 56 onto the back surface 12b of the porous base material 12, against the coating pressure (MPa) acting on the carbon paste 13 coated above the downstream lip 62. Therefore, in a coating part indicated by a dashed square in FIG. 10A in the thickness direction of the porous base material 12, the air pressure (MPa) acts on the porous base material 12 in the thickness direction from the back surface 12b of the porous base material 12. This air pressure exerts such an effect that prevents the carbon paste 13 coated from excessively penetrating into the porous base material 12.

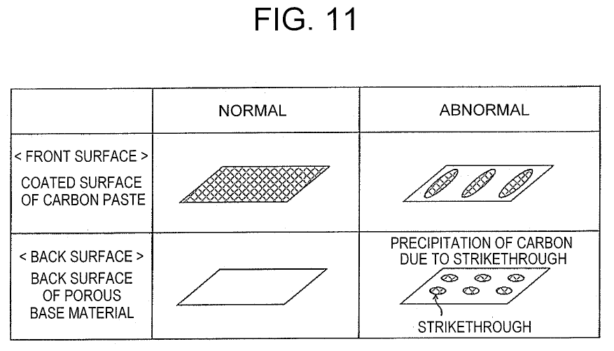

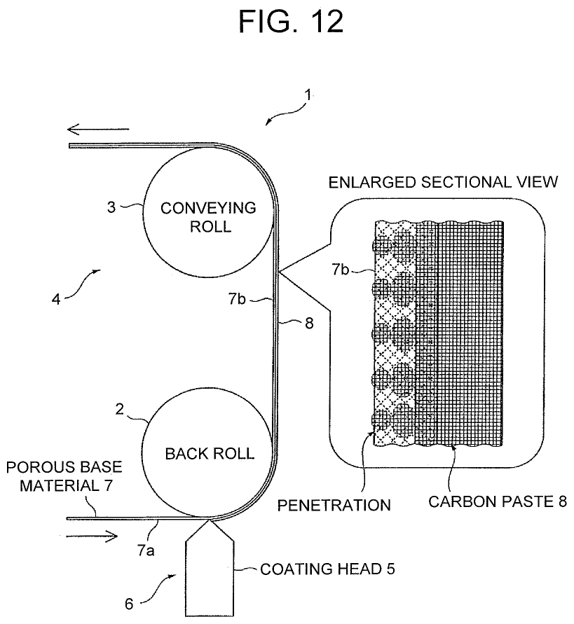

That is, in the manufacturing method for the gas diffusion layer, as shown in FIG. 11, when the coating step is failed to be performed properly, the carbon paste 13 coated on the front surface 12a of the porous base material 12 becomes uneven, which causes an abnormal coating condition in which strikethrough occurs in the back surface 12b. In this respect, it is conceivable to adjust the coating pressure by adjusting the coating gap G, but if the coating gap G is narrowed, the coating pressure rises instantly, which makes the adjustment difficult. To the contrary, the manufacturing apparatus 20B for the gas diffusion layer 11 according to the second embodiment exerts such effects that the front surface 12a of the porous base material 12 comes in an appropriate coated state and strikethrough does not occur.

In the manufacturing apparatus 20B for the gas diffusion layer 11 according to the second embodiment, the conveying mechanism 21B includes the back roll 56 having the plurality of blowout ports 56b formed in the outer peripheral surface coming into contact with the back surface 12b of the porous base material 12, and the blowing mechanism 23B sends air into the inside of the back roll 56 and injects this air from the plurality of blowout ports 56b.

With this configuration, the porous base material 12 is conveyed by the conveying mechanism 21B, the carbon paste 13 is coated on the front surface 12a of the porous base material 12 being conveyed by the coating mechanism 22B, and during the coating of the carbon paste 13, the air is injected by the blowing mechanism 23B from the plurality of blowout ports 56b of the back roll 56 toward the back surface 12b of the porous base material 12 coated with the carbon paste 13. As a result, the air is injected from the plurality of blowout ports 56b of the back roll 56 so as to push out the back surface 12b of the porous base material 12, against the coating pressure (MPa) acting on the carbon paste 13 coated above the downstream lip 62. Therefore, in the coating part indicated by a dashed square in FIG. 10A in the thickness direction of the porous base material 12, the air pressure (MPa) acts on the porous base material 12 in the thickness direction from the back surface 12b of the porous base material 12. This air pressure exerts such an effect that prevents the carbon paste 13 coated from excessively penetrating into the porous base material 12.

That is, in the manufacturing apparatus for the gas diffusion layer, as shown in FIG. 11, when the coating process is failed to be properly performed, the carbon paste 13 coated on the front surface 12a of the porous base material 12 becomes uneven, which causes an abnormal coating condition in which strikethrough occurs in the back surface 12b of the porous base material 12. In this respect, it is conceivable to adjust the coating pressure (MPa) by adjusting the coating gap G, but if the coating gap G is narrowed, the coating pressure rises instantly, which makes the adjustment difficult, so that strikethrough is likely to occur due to the coating pressure. Consequently, in the adjustment of the coating pressure, a range for producing non-defective products becomes narrowed. In addition, if the conveyance speed (m/sec) of the porous base material 12 is increased to promote mass production, the amount of air caught in the carbon paste 13 is increased; thus, the level of the liquid surface of the carbon paste 13 becomes convex or concave, that is, a so-called meniscus thereof varies, which makes it difficult to secure a normal coating condition of the carbon paste 13. If the viscosity (Pa·s) of the carbon paste 13 is decreased to accelerate the coating speed for promoting mass production, strikethrough occurs in the back surface 12b of the porous base material 12. Consequently, it becomes difficult to secure water repellency of the gas diffusion layer 11, resulting in a malfunction.

To the contrary, in the manufacturing apparatus 20B for the gas diffusion layer 11 according to the second embodiment, as described above, the air is injected from the plurality of blowout ports 56b of the back roll 56 so as to push out the back surface 12b of the porous base material 12, against the coating pressure (MPa) acting on the carbon paste 13 coated above the downstream lip 62. Therefore, in the coating part indicated by the dashed square in FIG. 10A in the thickness direction of the porous base material 12, the air pressure (MPa) acts from the back surface 12b of the porous base material 12 in the thickness direction of the porous base material 12. This air pressure brings the front surface 12a of the porous base material 12 into a proper coating condition, and thus it is possible to attain such an effect that strikethrough does not occur in the back surface 12b of the porous base material 12.

Although the first and second embodiments of the present disclosure have been described in detail, the present disclosure is not limited to the first and second embodiments described above, and various design changes can be made without departing from the spirit of the present disclosure set forth in the claims.

What is claimed is:

1. A manufacturing method for a gas diffusion layer comprising:
a coating step of coating a carbon paste on a front surface of a porous base material in a sheet shape; and
a blowing step of injecting a gas onto a back surface of the porous base material opposite to the front surface on which the carbon paste is coated in the coating step.

2. The manufacturing method for a gas diffusion layer according to claim 1, further comprising
a conveying step of conveying the porous base material by bringing a roll into contact with the back surface of the porous base material,
wherein
the coating step and the blowing step are performed on the porous base material being conveyed in the conveying step.

3. The manufacturing method for a gas diffusion layer according to claim 2, wherein
in the conveying step, the porous base material is conveyed such that in at least a part of the porous base material, the front surface of the porous base material is located on a lower side in a direction of gravity and the back surface of the porous base material is located on an upper side in the direction of gravity, and
in the coating step, the coating is performed on the front surface located on the lower side in the direction of gravity.

4. The manufacturing method for a gas diffusion layer according to claim 3, wherein
in the conveying step, a conveying direction of the porous base material horizontally conveyed such that the front surface is located on the lower side in the direction of gravity and the back surface is located on the upper side in the direction of gravity is changed upward in a direction opposite to the direction of gravity,
in the coating step, the coating is performed on the front surface of the porous base material being horizontally conveyed, and
in the blowing step, the gas is injected onto the back surface of the porous base material being conveyed along the direction opposite to the direction of gravity.

5. The manufacturing method for a gas diffusion layer according to claim 2, wherein
the roll is provided with a blowout port, and
in the blowing step, the gas is injected from the blowout port of the roll so as to blow the back surface of the porous base material in contact with the roll with the gas.

6. The manufacturing method for a gas diffusion layer according to claim 5, wherein
in the coating step, the coating is performed on the front surface of the porous base material at a position where the porous base material is in contact with the roll.

7. A manufacturing apparatus for a gas diffusion layer comprising:
a conveying section configured to convey a porous base material in a sheet shape;
a coating section configured to coat a carbon paste on a front surface of the porous base material being conveyed by the conveying section; and
a blowing section configured to inject a gas onto a back surface of the porous base material opposite to the front surface on which the carbon paste is coated by the coating section.

8. The manufacturing apparatus for a gas diffusion layer according to claim 7, wherein
the conveying section includes: a back roll configured to come into contact with the back surface of the porous base material; and a conveying roll configured to come into contact with the back surface of the porous base material downstream of the back roll in a conveying direction of the porous base material, and
the coating section includes a coating head disposed at a position facing the back roll with the porous base material interposed between the coating head and the back roll, and
the blowing section includes a blower disposed at a position between the back roll and the conveying roll, the blower arranged to face the back surface of the porous base material.

9. The manufacturing apparatus for a gas diffusion layer according to claim 8, wherein
the back roll is configured to change the conveying direction of the porous base material horizontally supplied such that the front surface is located on a lower side in a direction of gravity and the back surface is located on a upper side in the direction of gravity, upward in a direction opposite to the direction of gravity, and convey the porous base material,
the conveying roll is disposed at a position distant from and above the back roll in the direction of gravity, and is configured to change the conveying direction of the porous base material conveyed from the back roll along the direction opposite to the direction of gravity toward a direction inverse to the direction in which the porous base material is supplied to the back roll so as to horizontally convey the porous base material, and
the coating head is disposed below the back roll in the direction of gravity, and the blower is disposed between the back roll and the conveying roll.

10. The manufacturing apparatus for a gas diffusion layer according to claim 8, further comprising
a control section configured to adjust at least one of a distance from a blowout port of the blower to the back surface of the porous base material, a blowing temperature, or a blowing volume.

11. The manufacturing apparatus for a gas diffusion layer according to claim 7, wherein
the conveying section includes a roll configured to change a conveying direction of the porous base material such that the conveying direction is different before and after the carbon paste is coated by the coating section.

12. The manufacturing apparatus for a gas diffusion layer according to claim 7, wherein
the conveying section includes a back roll having a plurality of openings in an outer peripheral surface of the back roll coming into contact with the back surface of the porous base material, and
the blowing section is configured to send the gas into an inside of the back roll, and inject the gas from the plurality of openings.
